(19) United States
(12) Patent Application Publication
(10) Pub. No.: US 2015/0035348 A1
(43) Pub. Date: Feb. 5, 2015

(54) WHEEL COVER FOR TRUCK REAR WHEELS

(71) Applicant: Ming-Cheng WANG, TAINAN (TW)

(72) Inventor: Ming-Cheng WANG, TAINAN (TW)

(21) Appl. No.: 13/957,454

(22) Filed: Aug. 2, 2013

(51) Int. Cl. B60B 7/00; B60B 7/06

(52) U.S. Cl. CPC B60B 7/0013; B60B 7/06
USPC 301/108.1

(57) ABSTRACT

A wheel cover for a rear wheel of a truck includes a body, a hub cap and multiple bolt caps. The body has multiple recesses defined therein and each recess has a through hole defined through the inner end thereof Each recess has a resilient protrusion on the inside thereof The hub cap is mounted to the passage of the body. The bolt caps are respectively located in the recesses of the body and each bolt cap has multiple engaging recesses defined in outside thereof The resilient protrusions of the body are engaged with the engaging recesses to fix the bolt caps in the recesses of the body.

### FIELD OF THE INVENTION

The present invention relates to a wheel cover for truck rear wheels, and more particularly, to a wheel cover which has resilient protrusions in the recesses of the body and the resilient protrusions are engaged with the engaging recesses of the bolt caps to firmly connect the wheel cover to the rim.

### BACKGROUND OF THE INVENTION

The conventional rear wheels of a truck has hub, bolts and nuts exposed from outside of the rim, and a wheel cover is used to be mounted to the rim to hide the hub, the bolts and the nuts. As shown in FIGS. 1 to 3, the wheel cover 1 is used to hide the hub 20, the bolts 21 and the nuts 22 on the rim 2, and generally comprises a body 10 which has a passage 11 defined therethrough and a groove 12 is defined in outside of the body 10. A cover 13 is mounted to the passage 11 of the body 10 and has an engaging lip 14 on an inside thereof The engaging lip is engaged with the groove 12 of the body 10. The body 10 has multiple holes 15 and each hole 15 has a bolt cap 16 received therein. Each bolt cap 16 has an inner threaded hole 17. The cover 13 covers up the passage of the body 10, and the body 10 is mounted to the rim 2 as shown in FIGS. 2 and 3. The bolts 21 on the rim 2 respectively extend through the holes 15 of the body 10, and the bolt caps 16 are connected to the bolts 21. The bolt caps 16 are respectively located in the holes 15 to secure the body 10 to the rim 2. However, the bolt caps 16 are connected to the bolts 21 only by the inner threaded holes 17, the bolt caps 16 may be loose or drop from the rim 2 by vibration during moving.

The present invention intends to provide a wheel cover for a rear wheel of a truck and the wheel cover improves the shortcomings of the conventional one.

### SUMMARY OF THE INVENTION

The primary object of the present invention is to provide a wheel cover for the rear wheel of a truck, and the wheel cover is secured and does not drop or loose from the rim.

The present invention relates to a wheel cover for a rear wheel of a truck, and comprises a body having a hub housing protruding from the center of the body. The hub housing has a passage defined therethrough. A groove is defined in outside of the hub housing and two studs extend inward from the opening of the passage. The body has multiple recesses defined therein and the recesses are located at even distance from each other. Multiple tubular portions extend from the inside of the body and are located corresponding to the recesses respectively. Each recess has a through hole defined through the inner end thereof Each recess has a slot defined in the inside thereof and a resilient protrusion is located in the slot.

A hub cap is mounted to the passage of the body and has a lip protruding from the inside thereof The lip is engaged with the groove of the body. The hub cap has two notches defined in the periphery thereof and the two notches are located corresponding to the two studs of the body.

Multiple bolt caps are respectively located in the recesses of the body and each bolt cap has a space in which an inner tube is located. The inner tube has an inner threaded hole. Each bolt cap has multiple engaging recesses defined in the outside thereof The resilient protrusions of the body are engaged with the engaging recesses.

Preferably, the hub cap has a flange extending from the inside thereof

Preferably, each bolt cap has six sides formed on outside thereof and the six sides are adapted to be cooperated with a tool.

The advantages of the present invention are that the wheel cover is easily and quickly connected to the rim without worry of loosing and dropping from the rim. The hub, the bolts and the nuts are hidden by the wheel cover which prevents dust from entering the inside of the wheel cover and also protects the hub, the bolts and the nuts.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the conventional wheel cover;

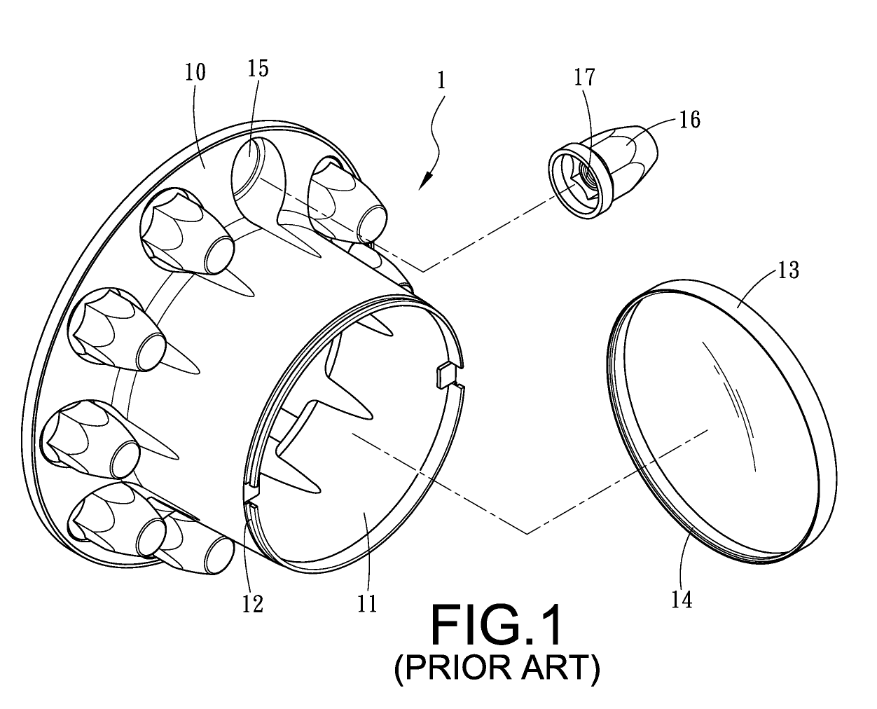

FIG. 2 is a cross sectional view of the conventional wheel cover;

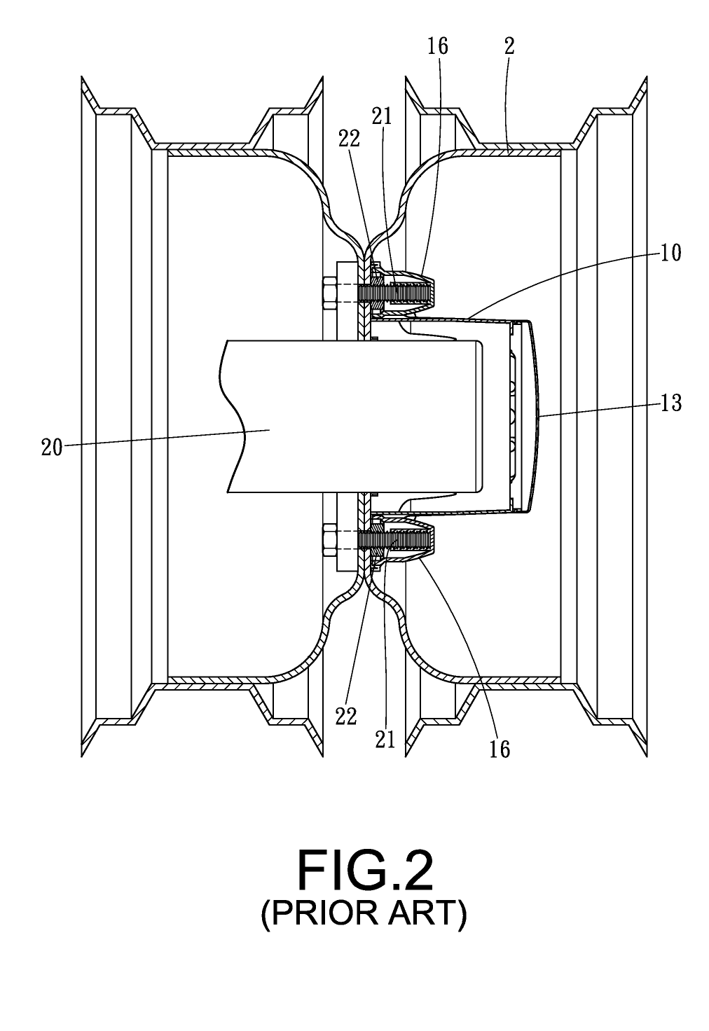

FIG. 3 is an enlarged cross sectional view of a portion of the conventional wheel cover;

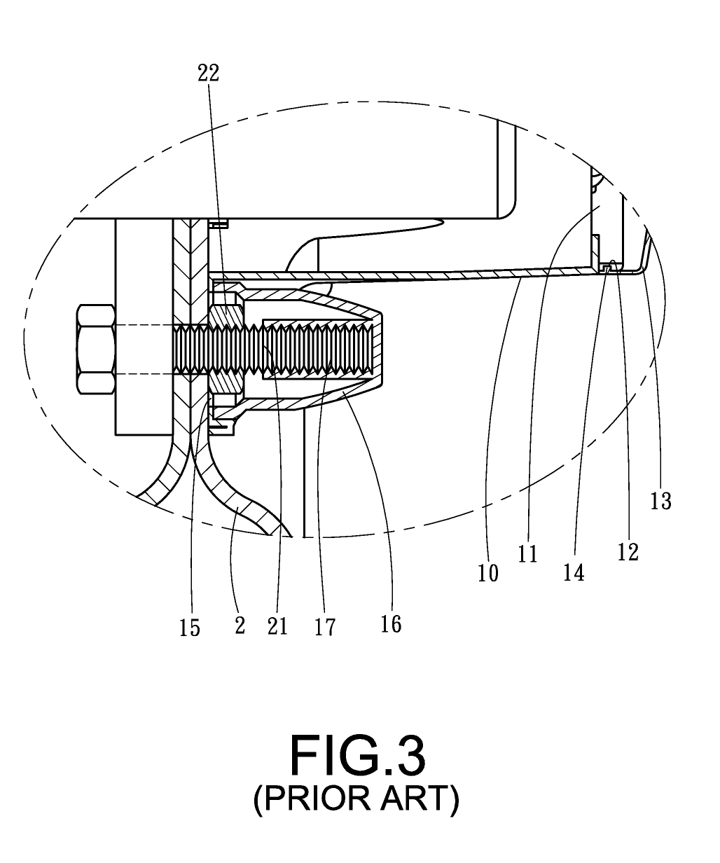

FIG. 4 is an exploded view to show the wheel cover of the present invention;

FIG. 5 is a cross sectional view of the wheel cover of the present invention;

FIG. 6 shows that a tool is used to install the wheel cover of the present invention to a rim;

FIG. 7 is a cross sectional view to show that the wheel cover of the present invention is installed to a rim;

FIG. 8 is an enlarged cross sectional view of the circled “A” in FIG. 7, and

FIG. 9 is an enlarged cross sectional view to show the bolt cap in the recess of the body.

### DETAILED DESCRIPTION OF THE PREFERRED EMBODIMENT

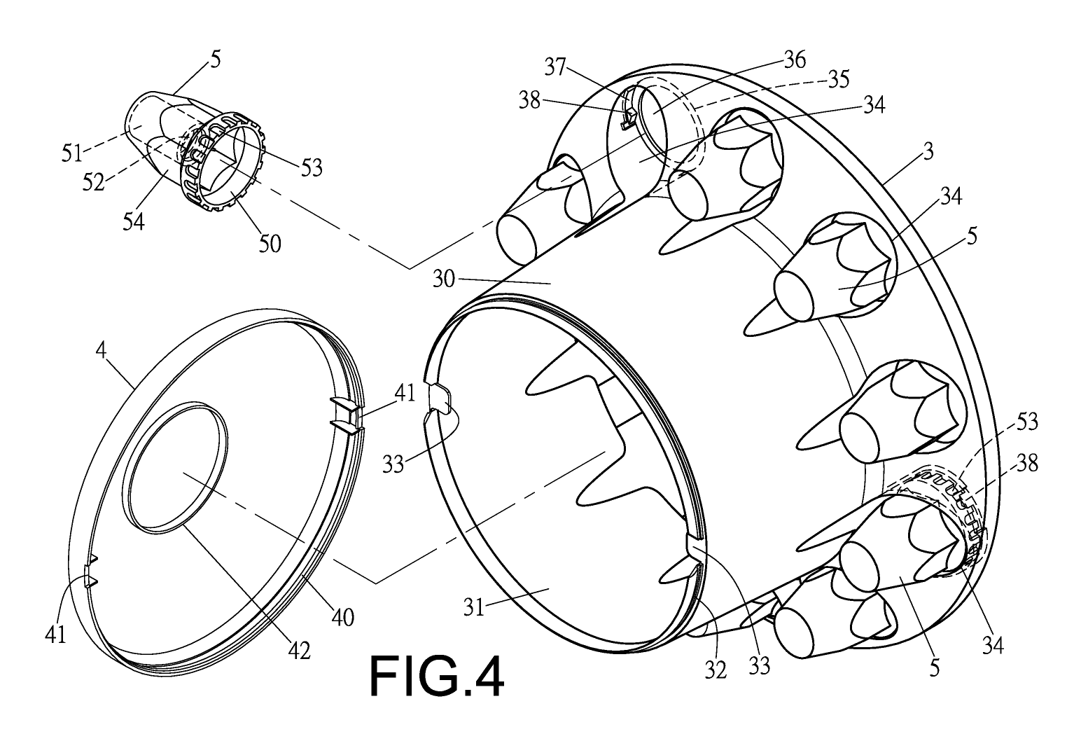

Referring to FIG. 4, the wheel cover for a rear wheel of a truck of the present invention comprises a body 3 having a hub housing 30 protruding from the center of the body 3, and the hub housing 30 has a passage 31 defined therethrough. A groove 32 is defined in the outside of the hub housing 30 and two studs 33 extend inward from the opening of the passage 31. The body 3 has multiple recesses 34 defined therein and the recesses 34 are located at even distance from each other. Multiple tubular portions 35 extend from the inside of the body 3 and are located corresponding to the recesses 34 respectively. Each recess 34 has a through hole 36 defined through the inner end thereof Each recess 34 has a slot 37 defined in the inside thereof and a resilient protrusion 38 is located in the slot 37.

A hub cap 4 is mounted to the passage 31 of the body 3 and has a lip 40 protruding from the inside thereof The lip 40 is engaged with the groove 32 of the body 3. The hub cap 4 has two notches 41 defined in the periphery thereof and the two notches 41 are located corresponding to the two studs 33 of the body 3. The hub cap 4 has a flange 42 extending from the inside thereof.

Multiple bolt caps 5 are respectively located in the recesses 34 of the body 3 and each bolt cap 5 has a space 50 in which an inner tube 51 is located. The inner tube 51 has an inner threaded hole 52. Each bolt cap 5 has multiple engaging recesses 53 defined in the outside thereof The resilient protrusions 38 of the body 3 are engaged with the engaging recesses 53. Each bolt cap 5 has six sides 54 formed on outside thereof and the six sides 54 are cooperated with a tool 7.

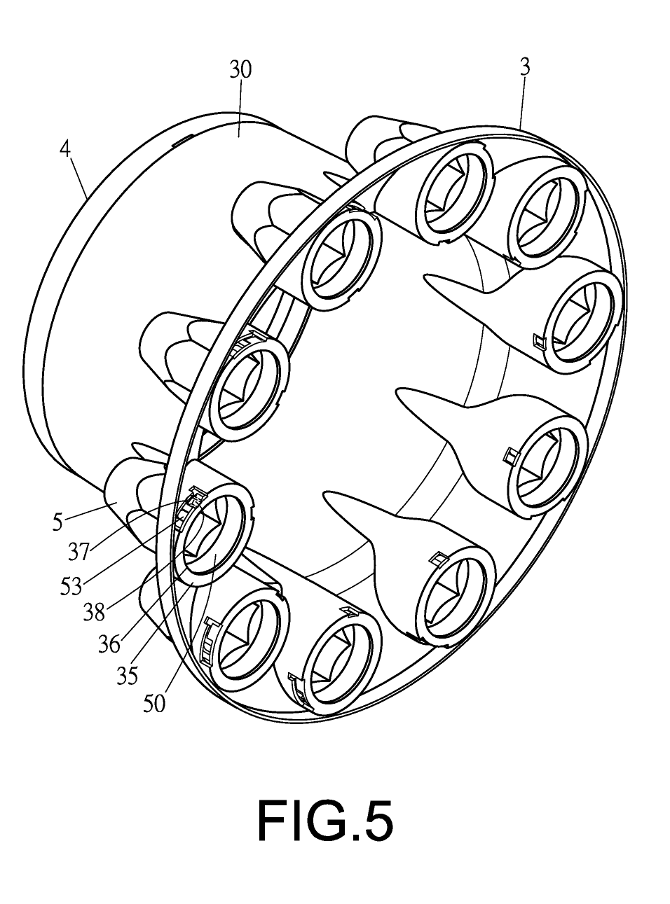

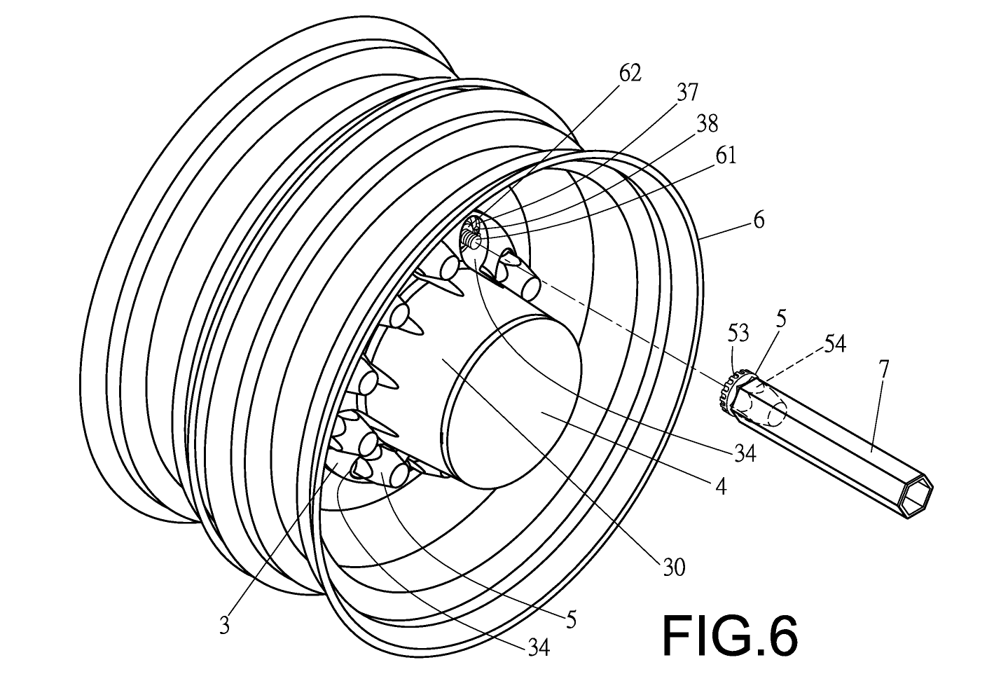

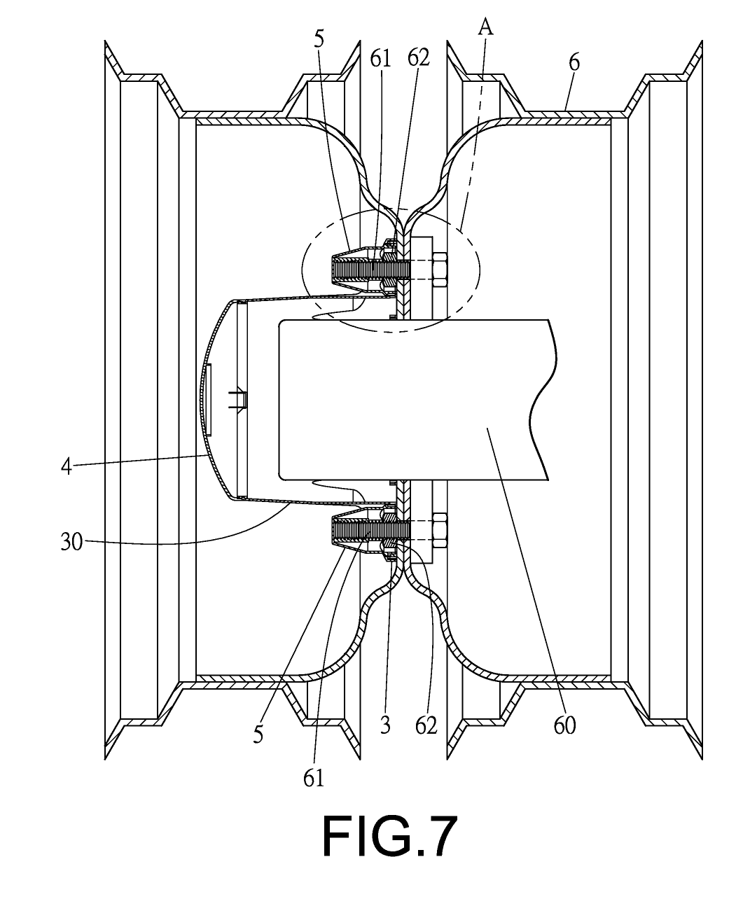

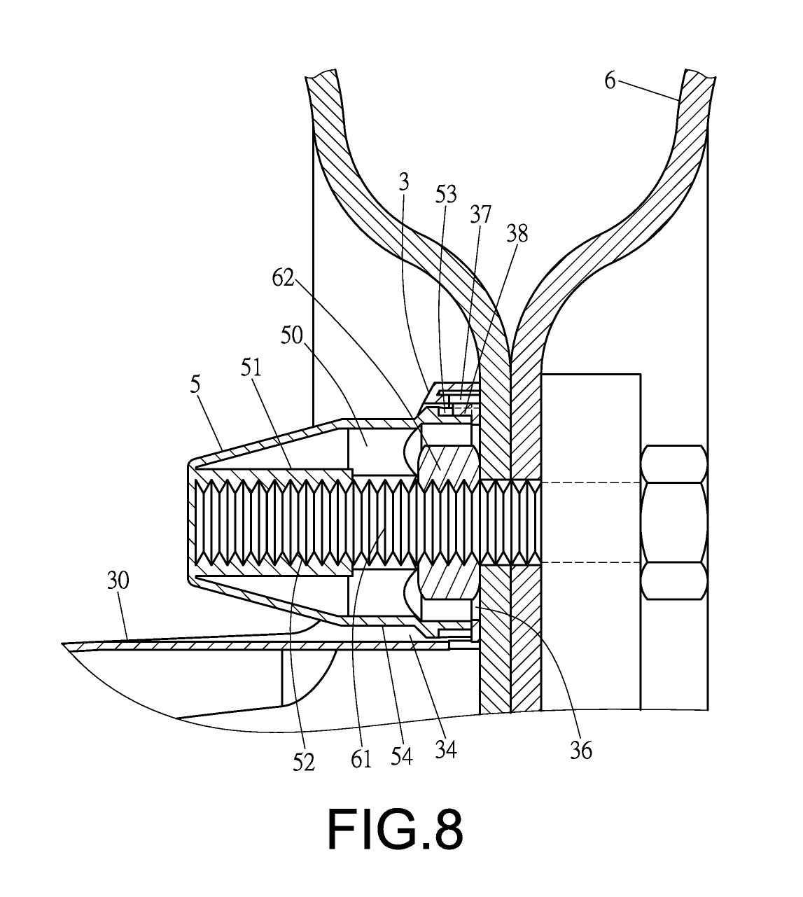

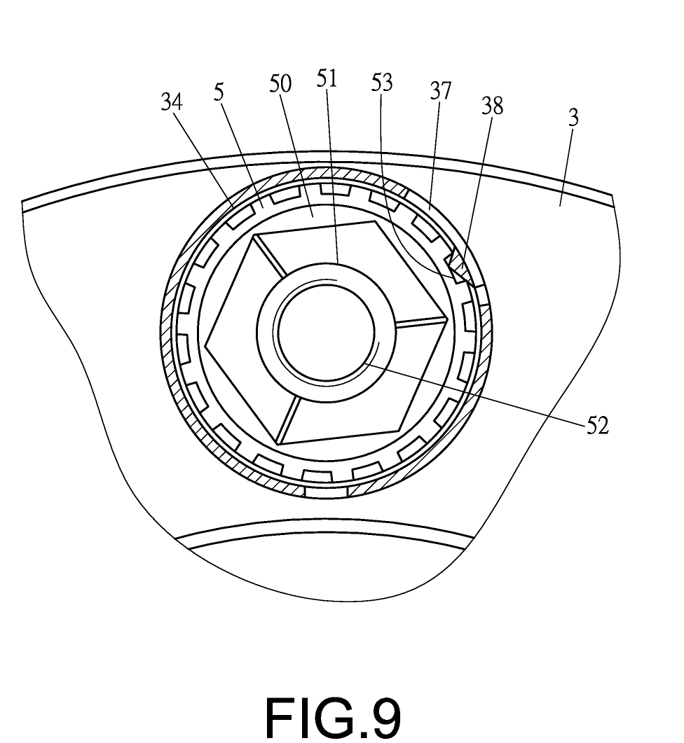

When assembling, as shown in FIGS. 4 to 8, the hub cap 4 is mounted to the passage 31 of the hub housing 30 of the body 3, and the studs 33 on the hub housing 30 are engaged with the notches 41 of the hub cap 4. The lip 40 is engaged with the groove 32 of the body 3 to secure the hub cap 4 to the passage 31 of the hub housing 30. The body 3 is then mounted to the rim 6, and the hub 60 of the rim 6 is inserted into the hub housing 30. The bolts 61 and the nuts 62 on the rim 6 respectively extend through the through holes 36 of the body 3, and the tool 7 is used to be mounted to the six sides 54 of each of the bolt caps 5 as shown in FIGS. 6 and 7. The tool 7 has a hollow hexagonal body which is mounted to the six sides 54 of each of the bolt caps 5 to rotate the bolt caps 5 to be secured in the recesses 34 of the body 3. The bolts 61 are threadedly connected to the inner threaded holes 52 of the inner tubes 51 of the bolt caps 5 to locate the bolts 61 and the nuts 62 in the spaces 50 of the bolt caps 5 respectively. The resilient protrusions 38 located in the recesses 34 of the body 3 are engaged with the engaging recesses 53 of the bolt caps 5 respectively as shown in FIGS. 8 and 9, so that the bolt caps 5 are secured and do not loose by vibration when the truck is moving. The wheel cover is easily and quickly connected to the rim 6 without worry of loosing and dropping from the rim 6. The hub 60, the bolts 61 and the nuts 62 are hidden by the wheel cover which prevents dust from entering the inside of the wheel cover and also protects the hub 60, the bolts 61 and the nuts 62.

While we have shown and described the embodiment in accordance with the present invention, it should be clear to those skilled in the art that further embodiments may be made without departing from the scope of the present invention.

What is claimed is:

1. A wheel cover for a rear wheel of a truck, comprising:
a body having a hub housing protruding from a center of the body, the hub housing having a passage defined therethrough, a groove defined in an outside of the hub housing and two studs extending inward from an opening of the passage, the body having multiple recesses defined therein and the recesses located at even distance from each other, multiple tubular portions extending from an inside of the body and located corresponding to the recesses respectively, each recess having a through hole defined through an inner end thereof, each recess having a slot defined in an inside thereof and a resilient protrusion located in the slot;
a hub cap mounted to the passage of the body and having a lip protruding from an inside thereof, the lip being engaged with the groove of the body, the hub cap having two notches defined in a periphery thereof and the two notches located corresponding to the two studs of the body, and
multiple bolt caps respectively located in the recesses of the body and each bolt cap having a space in which an inner tube is located, the inner tube having an inner threaded hole, each bolt cap having multiple engaging recesses defined in an outside thereof, the resilient protrusions of the body engaged with the engaging recesses.

2. The wheel cover as claimed in claim 1, wherein the hub cap has a flange extending from an inside thereof.

3. The wheel cover as claimed in claim 1, wherein each bolt cap has six sides formed on outside thereof and the six sides are adapted to be cooperated with a tool.
